(19) United States
(12) Patent Application Publication
(10) Pub. No.: US 2023/0047900 A1
(43) Pub. Date: Feb. 16, 2023

(54) MANUFACTURING METHOD OF TONER PARTICLES

(71) Applicant: CANON KABUSHIKI KAISHA, Tokyo (JP)

(72) Inventors: Shota Amano, Kanagawa (JP); Takeshi Tsujino, Shizuoka (JP); Junya Asaoka, Shizuoka (JP); Yuu Sasano, Shizuoka (JP); Koki Inoue, Shizuoka (JP); Toshiaki Yokoyama, Ibaraki (JP); Masahiro Kobayashi, Tokyo (JP)

(21) Appl. No.: 17/877,744

(22) Filed: Jul. 29, 2022

(30) Foreign Application Priority Data
Aug. 2, 2021 (JP) 2021-126530

(51) Int. Cl. G03G 9/08

(52) U.S. Cl. CPC G03G 9/0815

(57) ABSTRACT

A method of manufacturing toner particles, including a step of drying wet toner particles with a drying unit, the wet toner particles being obtained from an aqueous dispersion medium, wherein the drying unit includes a loop-type flash dryer in which the wet toner particles to be dried are supplied to a gas stream circulating in a loop-type drying pipe, the loop-type flash dryer includes: (i) a loop-type drying pipe; (ii) an inlet port for supplying wet toner particles to the loop-type drying pipe; (iii) an outlet port for discharging dried toner particles from the loop-type drying pipe; (iv) a first blowing port for blowing gas into the loop-type drying pipe; and (v) second blowing ports for blowing gas into the loop-type drying pipe.

### BACKGROUND OF THE INVENTION

### Field of the Invention

The present disclosure relates to a method of manufacturing toner particles to be used for forming an image in electrophotography.

### Description of the Related Art

In recent years, image forming apparatuses such as a copier and a laser beam printer require a toner that melts at a lower temperature in order to deal with saving energy and increase in printing speed.

To meet this requirement, a wet toner of which toner particles can be produced in an aqueous medium is often used because the wet toner is advantageous for introducing a large amount of a release agent and a crystalline resin, and the shape of the toner can be easily controlled. Wet manufacturing methods such like a suspension polymerization method using a polymerizable monomer or the like, an emulsion polymerization aggregation method, and a dissolution suspension method of granulating a binder resin or the like in a solvent have been proposed.

Generally, in these wet manufacturing methods, toner particles are obtained by a manufacturing process including a filtration step in which a toner particle slurry is subjected to the solid-liquid separation treatment to obtain wet toner particles, and a drying step in which the wet toner particles are dried with various methods to remove a dispersion medium after the filtration step.

In the drying step, a heat medium is generally used for removing the dispersion medium, and a flash dryer using gas as the heat medium is often used from the viewpoint of productivity. As described in Japanese Patent Application Laid-Open No. 2018-45069, of the flash dryers, a loop-type flash dryer is suitably used because by using the loop-type flash dryer, dried toner particles are appropriately discharged from a drying pipe and after drying, the toner particles are exposed to drying gas for a shorter period of time than when using other flash dryers, so that the toner is less liable to be excessively heated and the quality of the toner is kept to be constant.

However, the loop-type flash dryer has the following disadvantage. That is, since drying gas blown into the loop-type flash dryer described above is blown at high speed in order that the gas can crush, convey, and dry wet toner particles, high speed drying gas is localized in the drying pipe, and some of the wet toner particles collide with the inside of the drying pipe. Toner particles of the toner which is easy to fix a toner image at low temperature such like the toner of which a glass transition temperature of the toner particles is lowered, are likely to be fused to the inside of the pipe by collisions described above.

On the other hand, if the speed of drying gas is reduced in order to solve this disadvantage, the quantity of heat for drying is insufficient and drying efficiency is lowered.

### SUMMARY OF THE INVENTION

It is an aspect of the present disclosure to provide a method for manufacturing toner particles by which the above-mentioned disadvantage is solved. That is, the present disclosure provides the method for manufacturing toner particles, in which the drying treatment efficiency of an object to be treated is not lowered, and fusions caused by collisions of the wet toner particles with the inside surface of the drying pipe are suppressed in the step of drying the wet toner particles manufactured by the wet manufacturing method.

The present disclosure provides a method of manufacturing toner particles, including a step of drying wet toner particles with a drying unit, the wet toner particles being obtained from an aqueous dispersion medium,

wherein the drying unit includes a loop-type flash dryer in which the wet toner particles to be dried are supplied to a gas stream circulating in a loop-type drying pipe, the loop-type flash dryer includes:
(i) a loop-type drying pipe;
(ii) an inlet port for supplying wet toner particles to the loop-type drying pipe,
(iii) an outlet port for discharging dried toner particles from the loop-type drying pipe;
(iv) a first blowing port for blowing gas into the loop-type drying pipe; and
(v) a second blowing port for blowing gas into the loop-type drying pipe,

the first blowing port is positioned upstream of the second blowing port with respect to a conveying path of the wet toner particles,

when a gas flow speed of the gas supplied from the first blowing port is defined as A (m/s); a gas flow speed of the gas supplied from the second blowing port is defined as B (m/s); a gas flow rate of the gas supplied from the first blowing port is defined as C (m³/s); and a gas flow rate of the gas supplied from the second blowing port is defined as D (m³/s), the A, B, C and D satisfy the following formulae (1), (2) and (3):

4.5≤A≤14.5 (1);

19.0≤B≤38.5 (2); and

0.20≤C/(C+D)≤0.60 (3), and

a temperature of a gas stream supplied from the first blowing port and a temperature of a gas stream supplied from the second blowing port are both 60° C. to 80° C.

Further features of the present disclosure will become apparent from the following description of exemplary embodiments with reference to the attached drawings.

### BRIEF DESCRIPTION OF THE DRAWINGS

FIG. 1 is a schematic diagram of a drying apparatus including a loop-type flash dryer which can be adapted to the present disclosure.

FIG. 2 is a schematic diagram of a drying apparatus including a loop-type flash dryer which can be adapted to the present disclosure.

FIG. 3 is an explanatory diagram of an inlet port and a conveying path of wet toner particles in the loop-type flash dryer.

### DESCRIPTION OF THE EMBODIMENTS

Embodiments of the present disclosure will be described in detail below.

The present disclosure provides a method of manufacturing toner particles, including a step of drying wet toner particles with a drying unit, the wet toner particles being obtained from an aqueous dispersion medium, wherein the drying unit includes a loop-type flash dryer in which the wet toner particles to be dried are supplied to a gas stream circulating in a loop-type drying pipe, the loop-type flash dryer includes: (i) a loop-type drying pipe; (ii) an inlet port for supplying wet toner particles to the loop-type drying pipe; (iii) an outlet port for discharging dried toner particles from the loop-type drying pipe; (iv) a first blowing port for blowing gas into the loop-type drying pipe; and (v) a second blowing port for blowing gas into the loop-type drying pipe, the first blowing port is positioned upstream of the second blowing port with respect to a conveying path of the wet toner particles.

In addition, when a gas flow speed of the gas supplied from the first blowing port is defined as A (m/s); a gas flow speed of the gas supplied from the second blowing port is defined as B (m/s); a gas flow rate of the gas supplied from the first blowing port is defined as C (m³/s); and a gas flow rate of the gas supplied from the second blowing port is defined as D (m³/s), the A, B, C and D satisfy the following formulae (1), (2) and (3):

4.5≤A≤14.5 (1);

19.0≤B≤38.5 (2); and

0.20≤C/(C+D)≤0.60 (3), and

a temperature of a gas stream supplied from the first blowing port and a temperature of a gas stream supplied from the second blowing port are both 60° C. to 80° C.

The method of manufacturing toner particles of the present disclosure of the above configuration includes a drying step in which a dispersion medium and washing liquid used in a washing step are removed from wet toner particles including a binder resin, a colorant, a release agent and the like, to dry wet toner particles. The method of manufacturing toner particles of the present disclosure can be used for a dissolution suspension method, an emulsion polymerization aggregation method, a suspension polymerization method and other wet manufacturing methods for manufacturing toner particles.

A case where the present disclosure is used in the method for manufacturing toner particles using the suspension polymerization method is described below.

The suspension polymerization method is a method for manufacturing toner particles by granulating a polymerizable monomer composition which contains a polymerizable monomer and a colorant in an aqueous medium, forming particles of the polymerizable monomer composition, and polymerizing the polymerizable monomer contained in the particles of the polymerizable monomer composition.

Specifically, the method includes a preparation step of the polymerizable monomer composition, a granulation step, a polymerization step, a removal step of an organic volatile component, a washing step, a solid-liquid separation step, a drying step, and a classification step.

Each step of a case where the present disclosure is used in the method for manufacturing toner particles using the suspension polymerization method is described below.

(Preparation Step of Polymerizable Monomer Composition)

A polymerizable monomer composition containing a polymerizable monomer and a colorant is prepared. The colorant may be dispersed in advance in the polymerizable monomer by a medium stirring mill or the like, and then mixed with other compositions, or may be mixed with all compositions and then dispersed.

(Granulation Step)

The polymerizable monomer composition is charged into the aqueous medium containing an inorganic dispersion stabilizer and is dispersed to granulate, and then particles of the polymerizable monomer composition are formed in the aqueous medium to obtain a dispersion of the polymerizable monomer composition. The granulation step can be carried out, for example, using a vertical stirred tank equipped with a stirrer that has a high shear force. The stirrer that has a high shear force is not particularly limited, and a commercial stirrer such as a high shear mixer (manufactured by IKA Corporation), T.K. Homomixer (manufactured by Primix Corporation), T.K. Filmix (manufactured by Primix Corporation), CLEARMIX (manufactured by M Technique Co., Ltd.) can be used.

Examples of the inorganic dispersion stabilizer include a carbonate such as barium carbonate, calcium carbonate and magnesium carbonate; a metal phosphate such as aluminum phosphate, magnesium phosphate, calcium phosphate, barium phosphate, and zinc phosphate; a sulfate such as barium sulfate and calcium sulfate; a metal hydroxide such as calcium hydroxide, aluminum hydroxide, magnesium hydroxide, and ferric hydroxide. These can be used alone or in combination. These function as dispersion stabilizers by being present as fine particles in the aqueous medium.

(Polymerization Step)

The dispersion of the polymerizable monomer composition thus obtained is introduced in a polymerization step to obtain a dispersion of toner particles. In the polymerization step of the present disclosure, a general stirring vessel which is capable of adjusting temperature can be used.

A polymerization temperature is 40° C. or more, generally 50 to 90° C. The polymerization temperature may be held constant from beginning to end, or may be raised in the latter half of the polymerization step in order to obtain a desired molecular weight distribution. Any stirring blade can be used for stirring as long as it allows the dispersion liquid of a raw material for the toner to be suspended without stagnating and the temperature in the tank is kept uniform. Examples of the stirring blade or a stirring unit include general stirring blades such as a paddle blade, an inclined paddle blade, triple sweptback blades, a propeller blade, a disc turbine blade, a helical ribbon blade, and an anchor blade, as well as “FULLZONE” (manufactured by Kobelco Eco-Solutions Co., Ltd.), “Twinstar” (manufactured by Kobelco Eco-Solutions Co., Ltd.), “MAXBLEND” (manufactured by Sumitomo Heavy Industries, Ltd.), “Super-Mix” (manufactured by Satake Multimix Corporation), and “Hi-F Mixer” (manufactured by Soken Chemical & Engineering Co., Ltd.).

(Removal Step of Organic Volatile Component)

A volatile impurity such as an unreacted polymerizable monomer and by-products in the dispersion of the toner particles obtained in the polymerization step can be removed. A removal step of an organic volatile component can be carried out under normal pressure or reduced pressure, and various removal methods capable of removing the organic volatile component to a desired concentration can be used.

(Washing Step and Solid-Liquid Separation Step)

The dispersion of the toner particles may also be treated with an acid or an alkali to remove the dispersion stabilizer adhering to the surface of the toner particles. Thereafter, the toner particles are separated from the liquid phase by a general solid-liquid separation method, and the toner particles are washed by adding water again in order to completely remove the acid or the alkali and the dispersion stabilizer component dissolved therein. This washing step is repeated several times, and after sufficient washing, the solid-liquid separation is carried out again to obtain wet toner particles.

(Drying Step)

The obtained wet toner particles can be dried by removing water and the aqueous medium contained therein. In a general drying step, various drying methods such as vacuum drying, fluidized bed drying, and flash drying can be used.

In the present disclosure, a loop-type flash dryer having a first blowing port and a second blowing port as gas blowing ports is used in order to suppress deterioration of toner performance caused by a heat medium which is used in drying.

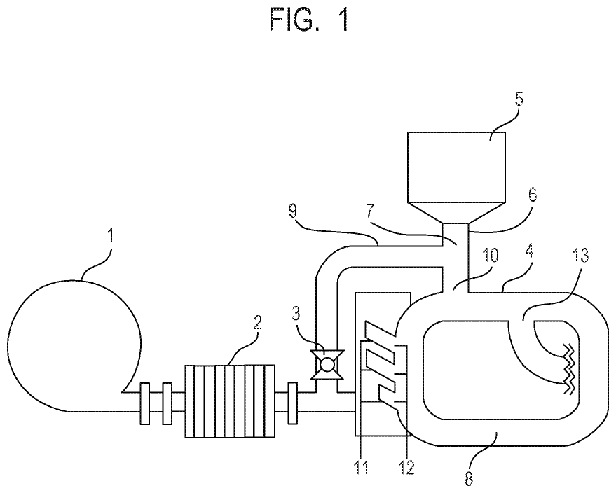

For example, gas discharged from a discharge blower 1 is heated by a gas heating device 2 and supplied to a loop-type flash dryer 4 illustrated in FIG. 1. The supplied gas is sent to a loop-type drying pipe 8 from a first blowing port 10 and second blowing ports 12. The gas flow rate is preferably adjusted by the opening of a gas flow rate adjusting valve 3 in order to freely adjust a gas flow rate of gas from the first blowing port 10 and gas from the second blowing ports 12.

Wet toner particles are supplied quantitatively from a feeder equipped in a wet toner particles supply hopper 5, and join gas circulating in the loop-type drying pipe 8. The wet toner particles are circulated together with gas to be dried and sent outside of the system of the loop-type drying pipe 8 from an outlet port 13.

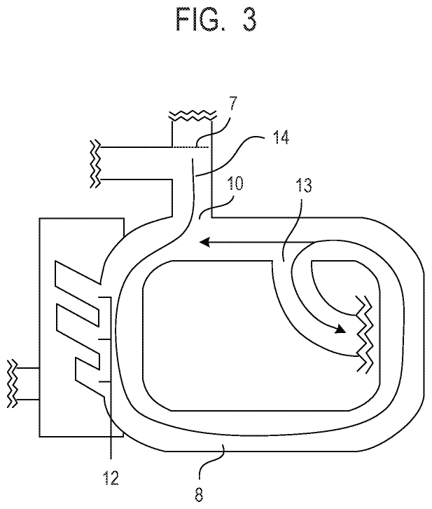

An inlet port 7 is an opening that is formed at a part where an inlet pipe 6 and the loop-type drying pipe 8 or a first blowing pipe 9 are joined. When the first blowing pipe 9 is joined to the inlet pipe 6, the inlet port 7 is an opening of the inlet pipe 6, and is illustrated by a dotted line in FIG. 3. The inlet port 7 for charging the wet toner particles can be freely positioned with respect to the loop-type drying pipe 8 and the first blowing pipe 9, and preferably arranged at the position where the first blowing pipe 9 is joined. When the inlet port 7 is joined to the first blowing pipe 9 as illustrated in FIG. 1, the wet toner particles follow a gas stream blown into the loop-type drying pipe 8 from the first blowing pipe 9, so that the wet toner particles become less likely to collide with the inside of the loop-type drying pipe 8.

The loop-type drying pipe 8 is a tube body in which the wet toner particles circulate. The shape of the loop-type drying pipe 8 is not particularly limited but preferably, the loop-type drying pipe 8 has a shape with curvature at a part where the traveling direction of gas is changed.

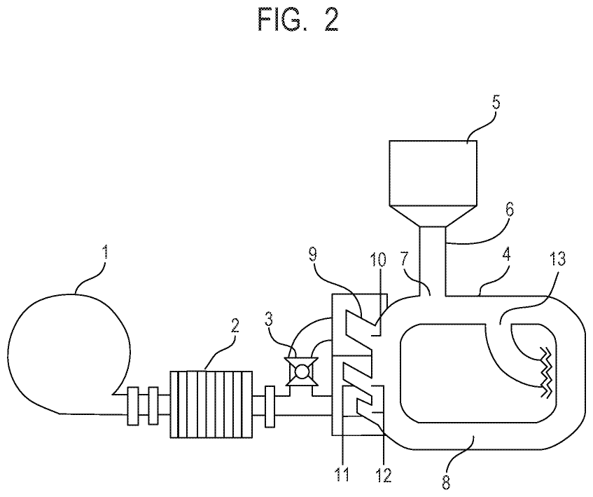

The first blowing port 10 is an opening that is formed at a part where the first blowing pipe 9 and the loop-type drying pipe 8 are joined. The first blowing port 10 is arranged for supplying gas having a smaller gas flow speed than gas from the second blowing ports 12 to impart the quantity of heat for drying while suppressing collisions of the wet toner particles into the loop-type drying pipe 8. The first blowing port 10 is positioned upstream of the second blowing ports 12 with respect to a conveying path 14 (FIG. 3) which is conveying the wet toner particles, and may be arranged in positions as illustrated in FIG. 1 and FIG. 2 with respect to the loop-type drying pipe 8, but the position of the first blowing port 10 is not limited thereto. Preferably, the gas supplied from the first blowing port 10 contains the wet toner particles before being blown into the loop-type drying pipe 8 as illustrated in FIG. 1.

The second blowing ports 12 are openings that are formed at parts where second blowing pipes 11 and the loop-type drying pipe 8 are joined. The second blowing ports 12 are provided to supply gas having a larger gas flow speed than the gas from the first blowing port 10 and to provide a propulsive force to the wet toner particles circulating in the loop-type drying pipe 8 to dry the wet toner particles efficiently. The second blowing ports 12 are positioned downstream of the first blowing port 10 with respect to the conveying path 14 of the wet toner particles, and may be arranged in positions as illustrated in FIG. 1 and FIG. 2 with respect to the loop-type drying pipe 8, but the positions of the second blowing ports 12 are not limited thereto.

The outlet port 13 is an opening that is formed at a part where an outlet pipe and the loop-type drying pipe 8 are joined.

In the present disclosure using the loop-type flash dryer having the above structure, the circulation speed is maintained to prevent the wet toner particles from excessively colliding with the inside of the drying pipe during drying the wet toner particles.

While the flash drying is very useful with respect to treatment efficiency in a viewpoint that the treatment is carried out continuously, the flash drying has the following disadvantage. That is, high speed drying gas is used in order to crush, convey, and dry the wet toner particles and the speed of the wet toner particles immediately after passing through the drying gas blowing port is the fastest. Due to the high speed, the wet toner particles collide with the inner surface of the drying pipe, and fusions are caused at that time. Although it is important to reduce the collision speed so as not to cause fusions, if the speed of drying gas is simply reduced, the quantity of heat for drying becomes insufficient and drying efficiency is lowered.

According to the present disclosure, by providing a new blowing port on the upstream side of the conventional drying gas blowing port, it is possible to make up for a shortage of the quantity of heat for drying while reducing the speed of drying gas. Therefore, it is possible to suppress fusions due to collisions without lowering drying efficiency.

In the present disclosure, the gas flow speed A of the gas supplied from the first blowing port (denoted by 10 in FIG. 1) is 4.5 m/s to 14.5 m/s. When the gas flow speed A of the gas supplied from the first blowing port is 4.5 m/s or more, the gas can circulate the gas in the drying pipe at a sufficient speed, and lowering of drying efficiency can be prevented. If the gas flow speed A of the gas supplied from the first blowing port is less than 4.5 m/s, the wet toner particles flow back to the blowing port because the speed of the gas from the first blowing port is too slow, and the drying treatment cannot be performed. When the gas flow speed A of the gas supplied from the first blowing port is 14.5 m/s or less, the gas flow speed of the gas in the drying pipe can be increased stepwise, so that the wet toner particles hardly collide with the wall surface in the drying pipe and fusions can be suppressed.

In the present disclosure, the gas flow speed B of the gas supplied from the second blowing port (denoted by 12 in FIG. 1) is 19.0 m/s to 38.5 m/s. When the gas flow speed B of the gas supplied from the second blowing port is 19.0 m/s or more, the gas can circulate the gas in the drying pipe at a sufficient speed, and lowering of drying efficiency can be prevented. When the gas flow speed B of the gas supplied from the second blowing port is 38.5 m/s or less, the wet toner particles hardly collide with the wall surface in the loop-type drying pipe because the gas flow speed of the gas inside the loop-type drying pipe is small enough, and fusions can be suppressed.

In the present disclosure, when the gas flow rate of the gas supplied from the first blowing port is defined as C (m³/s) and the gas flow rate of the gas supplied from the second blowing port is defined as D (m³/s), the C and D satisfy the following formulae:

0.20≤C/(C+D)≤0.60.

When C/(C+D) is 0.20 or more and the gas flow speed of blown gas is not too large, it is possible to suppress fusions in the drying pipe. Further, C/(C+D) is preferably 0.40 or more. When C/(C+D) is 0.60 or less, since disruption of the circulation flow of the gas in the drying pipe can be suppressed, the toner particles are not incorrectly collected in the discharge part, and the water content of dry toner particles can be kept at a low level.

In the present disclosure, preferably, the temperature of the gas stream (gas) supplied from the first blowing port and the temperature of the gas stream (gas) supplied from the second blowing port are both 60° C. to 80° C. When the temperatures of the gas supplied from the blowing ports are both 60° C. or more, a sufficient quantity of heat can be given to the wet toner particles, and drying efficiency can be enhanced. When the temperatures of the gas supplied from the blowing ports are both 80° C. or less, the toner can be dried without being adversely affected by heat and fusions can be prevented.

In the present disclosure, preferably, the loop-type flash dryer includes a plurality of second blowing ports. When a plurality of second blowing ports are provided, the gas flow speed of gas does not locally increase, so that the speed distribution of the gas in the drying pipe can be made more uniform, fusions can be the suppressed and drying efficiency can be enhanced. A plurality of first blowing ports may also be provided.

In the present disclosure, the toner particles preferably have a glass transition temperature (Tg) of 40° C. or more. When the toner particles have the Tg of 40° C. or more, since the toner particles can be dried without melting, and fusions in the drying pipe can be prevented.

(Classification Step)

The thus obtained toner particles have a sufficiently sharp particle size distribution as compared with a conventional grinded toner. However, when a sharper particle size distribution is required, toner particles which are out of a desired particle size distribution can be separated and removed by classifying with a wind classifier or the like.

Next, a material of the toner used for manufacturing the toner as described above is described below.

<Polymerizable Monomer>

The polymerizable monomer suitably used for the toner of the present disclosure includes a vinyl polymerizable monomer capable of radical polymerization. As the vinyl polymerizable monomer, a monofunctional polymerizable monomer or a polyfunctional polymerizable monomer can be used. Examples of the monofunctional polymerizable monomer include the following.

Styrene; a styrene derivative such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene; an acrylic monomer such as methyl acrylate, ethyl acrylate, n-propyl acrylate, isopropyl acrylate, n-butyl acrylate, isobutyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate and 2-benzoyloxyethyl acrylate; a methacrylic polymerizable monomer such as methyl methacrylate, ethyl methacrylate, n-propyl methacrylate, isopropyl methacrylate, n-butyl methacrylate, isobutyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate and dibutyl phosphate ethyl methacrylate; a vinyl ester such as an ester of methylene aliphatic monocarboxylic acids, vinyl acetate, vinyl propionate, vinyl butyrate, vinyl benzoate and vinyl formate; a vinyl ether such as vinyl methyl ether, vinyl ethyl ether and vinyl isobutyl ether; a vinyl ketone such as vinyl methyl ketone, vinyl hexyl ketone and vinyl isopropyl ketone.

Examples of the polyfunctional polymerizable monomer include diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis (4-(acryloxydiethoxy) phenyl) propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-Bis (4-(methacryloxydiethoxy) phenyl) propane, 2,2′-bis (4-(methacryloxypolyethoxy) phenyl) propane, trimethylolpropane trimethacrylate, tetramethylolmethanetetramethacrylate, divinylbenzene, divinylnaphthalene, divinyl ether.

In the present disclosure, the monofunctional polymerizable monomer described above is used alone or in combination, or the monofunctional polymerizable monomer and the polyfunctional polymerizable monomer described above are used in combination. Among the monomers mentioned above, styrene or a styrene derivative alone or in combination, or styrene and a styrene derivative in combination with other monomers is preferably used from view of the developing characteristic and durability of the toner.

<Colorant>

Examples of a colorant preferably used in the present disclosure include the following organic pigment, dye, or inorganic pigment.

As the organic pigment or the organic dye as a cyane colorant, a copper phthalocyanine compound and its derivative, an anthraquinone compound and a basic dye lake compound can be used.

Specific examples include C.I. Pigment Blue 1, 7, 15, 15: 1, 15: 2, 15: 3, 15: 4, 60, 62 and 66.

Examples of the organic pigment or the organic dye as a magenta colorant are as follows.

A condensed azo compound, a diketopyrrolopyrrole compound, an anthraquinone, a quinacridone compound, a basic dye lake compound, a naphthol compound, a benzimidazolone compound, a thioindigo compound, and a perylene compound.

Specific examples include C.I. Pigment Red 2, 3, 5, 6, 7, C.I. Pigment Violet 19, C.I. Pigment Red 23, 48: 2, 48: 3, 48: 4, 57: 1, 81: 1, 122, 144, 146, 150, 166, 169, 177, 184, 185, 202, 206, 220, 221, 254.

As the organic pigment or the organic dye as a yellow colorant, a compound represented by a condensed azo compound, an isoindolinone compound, an anthraquinone compound, an azo metal complex, a methine compound and an allylamide compound is used.

Specific examples include C.I. Pigment Yellow 12, 13, 14, 15, 17, 62, 74, 83, 93, 94, 95, 97, 109, 111, 120, 127, 128, 129, 147, 154, 155, 168, 174, 175, 176, 180, 181, 191, 194.

As a black colorant, carbon black and a colorant toned to black using the yellow/magenta/cyan colorants described above are used.

These colorants can be used alone or in combination and further can be used in solid solution form. The colorant used for the toner of the present disclosure is selected from the viewpoints of hue angle, saturation, lightness, light resistance, OHP transparency, and dispersibility in the toner.

The colorant is preferably added in an amount of 1 part by mass to 20 parts by mass based on 100 parts by mass of the binder resin and used.

When selecting a colorant, attention must be paid to the polymerization inhibition and aqueous phase migration of the colorant. Especially, since many of dyes and the carbon black are likely to inhibit polymerization, attention must be paid when using them. Preferably, these materials are subjected in advance to surface modification, for example, hydrophobization treatment by a substance not inhibiting polymerization. As a method of treating the surface of the dye, the polymerizable monomer is polymerized in advance in the presence of these dyes, and the obtained colored polymer is added to a raw material for the toner such as a polymerizable monomer composition. The carbon black may be grafted with a substance reacting with the surface functional group of the carbon black such like polyorganosiloxane, in addition to the same treatment of the above dye.

<Release Agent>

As the release agent used in the present disclosure, a wax in a solid state at room temperature is preferable in terms of blocking resistance, multi-sheet durability, low-temperature fixability, and offset resistance of the toner.

Examples of the wax include a paraffin wax, a polyolefin wax, a microcrystalline wax, a polymethylene wax such as a Fischer-Tropsch wax, an amide wax, a higher fatty acid, a long chain alcohol, an ester wax, a graft polymer thereof, and a block polymer thereof. The low molecular weight components are preferably removed from the wax. Further, the wax having a sharp maximum endothermic peak of the endothermic curve obtained by the differential scanning calorimetry is preferable. In order to improve the translucency of the image fixed to the OHP, a linear ester wax is particularly preferably used. The linear ester wax is preferably contained in an amount of 1 part by mass to 40 parts by mass, more preferably, 4 parts by mass to 30 parts by mass based on 100 parts by mass of the polymerizable monomer.

In the present disclosure, in order to increase the plasticity of the toner particles and improve the fixability in the low temperature region, a second release agent having a melting point lower than 80° C. can be used in combination. As the second release agent, a linear alkyl alcohol having 15 to 100 carbon atoms, a linear fatty acid, a linear acid amide, a linear ester or a wax of a derivative of montane is preferably used. The wax from which impurities such as a liquid fatty acid are removed in advance is more preferable.

<Charge Control Agent>

The toner manufactured by the method of the present disclosure may contain a charge control agent. A known charge control agent can be used. As examples of the charge control agent controlling the toner to be negatively charged, an organometallic compound and a chelate compound are effective. Further, a monoazo dye metal compound, an acetylacetone metal compound, an aromatic hydroxycarboxylic acid, aromatic monocarboxylic and polycarboxylic acids and metal salts thereof, an anhydride thereof, an ester thereof, a phenol derivative such as bisphenol, an urea derivative, a metal-containing salicylic acid compound, a quaternary ammonium salt, a calixarene, a silicon compound, a styrene-acrylic acid copolymer, a styrene-methacrylic acid copolymer, a styrene-acrylic-sulfonic acid copolymer, and a non-metal carboxylic acid compound are also included.

Examples of the charge control agent controlling the toner to be positively charged include nigrosine and a modified product by a metal salt of a fatty acid; a quaternary ammonium salt such as tributylbenzylammonium 1-hydroxy-4-naphthosulfonate and tetrabutylammonium tetrafluoroborate; an onium salt such as a phosphonium salt and a lake pigment thereof, a triphenylmethane dye and a lake pigment thereof, (as a laking agent, tungstophosphoric acid, molybdophosphoric acid, tungstomolybdophosphoric acid, tannic acid, lauric acid, gallic acid, ferricyanide and ferrocyanide), a metal salt of a higher fatty acid. These may be used alone or in combination. Among these, particularly, the quaternary ammonium salt is preferably used as the charge control agent.

These charge control agents are preferably used in an amount of 0.01 part by mass to 20 parts by mass, more preferably, 0.5 part by mass to 10 parts by mass based on 100 parts by mass of the polymerizable monomer.

<Polymerization Initiator>

Examples of a polymerization initiator that can be used in the present disclosure include an azo polymerization initiator. Examples of the azo polymerization initiator include 2,2′-Azobis (2,4-dimethylvaleronitrile), 2,2′-Azobisisobutyronitrile, 1,1′-Azobis (cyclohexane-1-carbonitrile), 2,2′-Azobis-4-methoxy-2,4-dimethylvaleronitrile, azobismethylbutyronitrile.

An organic peroxide polymerization initiator can also be used as the polymerization initiator. Examples of the organic peroxide polymerization initiator include benzoyl peroxide, methyl ethyl ketone peroxide, diisopropyl peroxycarbonate, cumene hydroperoxide, 2,4-dichlorobenzoyl peroxide, lauroyl peroxide, tert-butyl peroxypivalate.

A redox polymerization initiator in which an oxidizing agent and a reducing agent are combined can also be used as the polymerization initiator. Examples of the oxidizing agent include hydrogen peroxide, an inorganic peroxide of persulfate (a sodium salt, a potassium salt, an ammonium salt, or the like), and an oxidizing metal salt such as a tetravalent cerium salt. Examples of the reducing agent include a reducing metal salt (a divalent iron salt, a monovalent copper salt, and a trivalent chromium salt), ammonia, an amino compound such as a lower amine (an amine having 1 to 6 carbon atoms, such as methylamine and ethylamine) and hydroxylamine, a reducing sulfur compound such as sodium thiosulfate, sodium hydrosulfite, sodium bisulfite, sodium sulfite, and sodium formaldehyde sulfoxylate, a lower alcohol (having 1 to 6 carbon atoms), ascorbic acid and its salt; and a lower aldehyde (having 1 to 6 carbon atoms). The polymerization initiator is selected in consideration of a 10-hour half-life temperature and used alone or in combination. The amount of the polymerization initiator to be added varies depending on the desired degree of polymerization, but generally, 0.5 part by mass to 20 parts by mass based on 100 parts by mass of the polymerizable monomer is added.

<Crosslinking Agent>

Various crosslinking agents can be used in the present disclosure. Examples of the crosslinking agent include divinylbenzene, 4,4′-divinylbiphenyl, hexanediol diacrylate, ethylene glycol diacrylate, ethylene glycol dimethacrylate, diethylene glycol diacrylate, diethylene glycol dimethacrylate, glycidyl acrylate, glycidyl methacrylate, trimethylolpropane triacrylate, trimethylolpropane trimethacrylate.

<Binder Resin>

The binder resin used in the dissolution suspension method is not particularly limited and can be suitably selected from the common binder resins. The binder resin includes a homopolymer and a copolymer, for example, a styrene such as styrene and chlorostyrene; a monoolefin such as ethylene, propylene, butylene, and isoprene; a vinyl ester such as vinyl acetate, vinyl propionate, vinyl benzoate, and vinyl butyrate; an α-methylene aliphatic monocarboxylate ester such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate; a vinyl ether such as vinyl methyl ether, vinyl ethyl ether, and vinyl butyl ether; and a vinyl ketone such as vinyl methyl ketone, vinyl hexyl ketone, and vinyl isopropenyl ketone.

Examples of the polymer of the styrene described above or the polymer of a substitute of the styrene include polystyrene, poly p-chlorostyrene, and polyvinyl toluene. Examples of the copolymer of the styrene include styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleate ester copolymer.

Examples of the particularly typical binder resin include a polystyrene resin, a polyester resin, a styrene-alkyl acrylate copolymer, a styrene-alkyl methacrylate copolymer, a styrene-acrylonitrile copolymer, a styrene-butadiene copolymer, a styrene-maleic anhydride copolymer, a polyethylene resin, and a polypropylene resin. These may be used alone or in combination.

<External Additive>

In the manufacturing method of the present disclosure, an external additive can be used for the purpose of imparting various characteristics to the toner. The external additive preferably has a particle diameter of one-tenth or less of the average particle diameter of the toner particles from the viewpoint of durability of the toner when the external additive is added. Examples of the external additive include a metal oxide such as aluminum oxide, titanium oxide, strontium titanate, cerium oxide, magnesium oxide, chromium oxide, tin oxide, and zinc oxide; a nitride such as silicon nitride; a carbide such as silicon carbide; an inorganic metal salt such as calcium sulfate, barium sulfate, and calcium carbonate; a metal salt of a fatty acid, such as zinc stearate and calcium stearate; carbon black and silica.

These external additives are used in an amount of 0.01 part by mass to 10 parts by mass and preferably used in an amount of 0.05 part by mass to 5 parts by mass based on 100 parts by mass of the toner particles. The external additive may be used alone or in combination, and the external additive which is hydrophobized is more preferably used.

<Magnetic Body>

The manufacturing method of the present disclosure can also be applied to manufacturing of a magnetic toner containing a magnetic body. The magnetic body contained in the toner can also serve as a colorant. In the present disclosure, examples of the magnetic body contained in the magnetic toner include an iron oxide such as magnetite, hematite, and ferrite; a metal such as iron, cobalt, and nickel or an alloy of these metals with a metal such as aluminum, cobalt, copper, lead, magnesium, tin, zinc, antimony, beryllium, bismuth, cadmium, calcium, manganese, selenium, titanium, tungsten, and vanadium; and a mixture thereof.

These magnetic bodies have a volume average particle diameter (Dv) of 0.5 μm or less, preferably have a volume average particle diameter (Dv) of 0.1 to 0.5 μm.

The volume average particle diameter (Dv) of the magnetic bodies is calculated by determining the equivalent diameter of a circle equal to the projected area of 100 magnetic bodies in a field of view of a photograph with magnification of 10,000 to 40,000 times using a transmission electron microscope (TEM).

The magnetic body content in the toner is 20 parts by mass to 200 parts by mass, preferably, 40 parts by mass to 150 parts by mass based on 100 parts by mass of the polymerizable monomers.

Further, the magnetic body having a saturation magnetization ((s) of 50 to 200 Am²/kg and a residual magnetization (or) of 2 to 20 Am²/kg when 800 kA/m is applied is preferable. These magnetic properties of the magnetic body are measured with an external magnetic field of 79.6 kA/m at room temperature of 25° C. using a vibrating magnetometer VSM P-1-10 (manufactured by Toei Industry Co., Ltd.).

Further, in order to improve the dispersibility of these magnetic bodies in the toner particles, the surface of the magnetic body is preferably hydrophobized. A coupling agent such as a silane coupling agent and a titanium coupling agent is used for the hydrophobic treatment. The silane coupling agent is preferably used among them. Examples of the silane coupling agent include vinyltrimethoxysilane, vinyltriethoxysilane, γ-methacryloxypropyltrimethoxysilane, vinyltriacetoxysilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-hexadecyltrimethoxysilane, and n-octadecyltrimethoxysilane.

<Developer>

The toner manufactured by the method of the present disclosure can be used as a one-component developer or a two-component developer as described above.

In the case of using the magnetic toner containing the magnetic body as the one-component developer, the magnetic toner is conveyed or charged by using a magnet built in a developing sleeve. When a non-magnetic toner containing no magnetic body is used, the toner is forcibly charged by rubbing the toner on the developing sleeve using a blade and a fur brush so that the toner is adhered on the sleeve to convey the toner.

When the toner obtained by the manufacturing method of the present disclosure is used as the two-component developer, a carrier is used together with the toner as the developer. The carrier used in the present disclosure is not particularly limited, and is primarily composed of iron, copper, zinc, nickel, cobalt, manganese and chromium atoms alone or in a composite ferrite state.

The shape of the carrier is also important in order to control the saturation magnetization and the electrical resistance in a wide range. For example, a shape such as a spherical shape, a flat shape or an amorphous shape is selected and further, it is preferable to control the microstructure of the carrier surface state, for example, the surface irregularity. In general, carrier core particles are formed in advance by firing and granulating the metal compound described above, and then a resin is coated. In order to reduce the load of the carrier on the toner, the metal compound and the resin are kneaded, grinded and classified to obtain a low-density dispersion carrier. Further, it is also possible to obtain a polymerized carrier dispersed in a spherical shape by suspension polymerization of a kneaded product of the metal compound and the polymerizable monomer in an aqueous medium.

The particle diameter of the carrier is measured as 50% average particle diameter of the volume basis of the carrier using a laser diffraction particle size distribution measuring instrument HELOS which is made by Sympatec Corporation and equipped with a dry disperser RODOS.

The 50% average particle diameter of the volume basis of the carrier is 10 to 100 μm, preferably 20 to 50 μm.

When the two-component developer is prepared, the mixing ratio of the carrier and the toner of the present disclosure is 2 to 15% by mass, preferably 4 to 13% by mass, as the toner concentration in the developer. In such a range, a good result is usually obtained.

The measurement of the water content and the glass transition temperature in Examples was carried out in accordance with the following method.

<Measurement of Water Content>

The water content is the value obtained when 5 g of the toner particles are collected in an aluminum pan, which are precisely weighed (A (g)), left at rest for one hour in a dryer set at a temperature of 105° C., and the toner particles having been cooled are precisely weighed (B (g)) to make calculation according to the following expression: water content (%)=((A−B)/A)×100

<Measurement of Glass Transition Temperature (Tg) of Toner Particles>

The glass transition temperature (Tg) is measured according to ASTM D 3418-82 using a differential scanning calorimetry analyzer “Q 1000” (manufactured by TA Instruments Corporation). The melting points of indium and zinc are used to correct the temperature of a detecting portion of the apparatus, and the heat of melting of indium is used to correct the quantity of heat. Concretely, about 3 mg of the toner particles are precisely weighed, put on an aluminum pan, and measurement is carried out in a measuring range of 30 to 200° C. under conditions w % here the temperature rises 10° C. every minute using an empty aluminum pan as a reference. The change of specific heat is observed in the temperature range of 40° C. to 100° C. during the raising temperature process. A straight line extending the baseline before the specific heat change is defined as a first straight line, a straight line extending the baseline after the specific heat change is defined as a second straight line, and a straight line equidistant in the vertical direction from the first straight line and the second straight line is defined as a third straight line. The temperature at the intersection point of the third straight line and the stepwise varying part of the differential heat curve (so-called mid-point glass transition temperature) is defined as the glass transition temperature Tg of the toner particles.

### EXAMPLES

The present disclosure will be specifically described with reference to the following Examples. In Examples, wet toner particles are produced and the obtained wet toner particles are dried with a drying unit under predetermined conditions.

<Preparation of Wet Toner Particles 1>

Wet toner particles 1 were manufactured by the following procedure.

(Preparation Step of Pigment Dispersion Composition)

Based on 23.0 parts by mass of styrene, 1.88 parts by mass of C.I. Pigment Yellow 155 and 0.58 part by mass of a charge control agent (Bontron E88; manufactured by Orient Chemical Industries Co., Ltd.) were prepared. These were introduced into Attritor (manufactured by Nippon Coke & Engineering Co., Ltd.), and agitated at 200 rpm at a temperature of 25° C. for 300 minutes using zirconia beads having a radius of 5.00 mm to prepare a pigment dispersion composition.

(Preparation Step of Colorant-Containing Composition)

The following materials were put into the same container, and were mixed and dispersed at a peripheral speed of 20 m/s using T.K.Homomixer (manufactured by Primix Corporation).

Pigment dispersion composition 25.02 parts by mass

Styrene 11.51 parts by mass

n-Butyl acrylate 13.42 parts by mass

Polyester resin 1.92 parts by mass

Styrene-methacrylic acid-methyl methacrylate-α-methylstyrene copolymer 5.75 parts by mass (styrene/methacrylic acid/methyl methacrylate/α-methylstyrene=80.85/2.50/1.65/15.0, Mp=19,700, Mw=7,900, TgB=96° C., Acid value=12.0 mg KOH/g, Mw/Mn=2.1)

Sulfonic acid group-containing resin (Acrybase FCA-1001-NS, manufactured by Fujikura Kasei Co., Ltd.) 0.05 part by mass

Further, after heating to 60° C., 4.79 parts by mass of microcrystalline wax (Hi-Mic-2065; manufactured by Nippon Seiro Co., Ltd.) having a melting point of 75° C. was input as the release agent and was dispersed and mixed for 30 minutes. Then, 4.31 parts by mass of 2,2′-Azobis (2,4-dimethylvaleronitrile) as the polymerization initiator was dissolved to prepare a colorant-containing composition

(Preparation Step of Aqueous Dispersion Medium)

In a granulation tank, 129.71 parts by mass of ion exchange water, 2.51 parts by mass of sodium phosphate dodecahydrate, 1.13 parts by mass of hydrochloric acid of 10% by mass were input to prepare an aqueous sodium phosphate solution, and the solution was heated to 60° C. An aqueous calcium chloride solution was obtained by dissolving 1.46 parts by mass of calcium chloride dihydrate in 10.20 parts by mass of ion exchange water. The aqueous calcium chloride solution was added to the aqueous sodium phosphate solution and the mixture was stirred at a peripheral speed of 25 m/s for 30 minutes using T.K.Homomixer (manufactured by Primix Corporation).

(Granulation Step)

The colorant-containing composition was charged into the aqueous dispersion medium, and the mixture was stirred at a peripheral speed of 25 m/s for 20 minutes under a nitrogen atmosphere at a temperature of 60° C. using T.K.Homomixer (manufactured by Primix Corporation) to obtain a dispersion of the colorant-containing composition.

(Reaction Step)

The dispersion of the colorant-containing composition was input to another tank, heated to 70° C. (reaction temperature) while being stirred with a paddle stirring blade, and reacted for four hours. Thereafter, the temperature was further raised to 85° C., and the reaction was carried out for two hours to obtain a dispersion of the toner particles.

(Washing and Filtration Step)

After cooling the dispersion of the toner particles which had undergone a step of removing an organic volatile component, hydrochloric acid was added to adjust the pH value of the dispersion of the toner particles to 1.4, and the dispersion of the toner particles was stirred for two hours. Thereafter, the dispersion of the toner particles was filtered, and then, washed and filtered with water in an amount equal to that of the filtrate to obtain wet toner particles 1. The wet toner particles 1 had a weight average particle diameter of 7.0 μm and the water content of the wet toner particles 1 was 24%.

<Preparation of Wet Toner Particles 2 and Wet Toner Particles 3>

In the preparation step of the colorant-containing composition, wet toner particles 2 and wet toner particles 3 were obtained under the same conditions and by the same method as the wet toner particles 1 except for the differences shown in Table 1.

TABLE 1

| | Styrene | n-Butyl acrylate |
|---|---|---|
| | (parts by mass) | (parts by mass) |
| Wet toner particles 1 | 11.51 | 13.42 |
| Wet toner particles 2 | 7.06 | 17.87 |
| Wet toner particles 3 | 6.47 | 18.46 |

### Example 1

(Drying Step)

The wet toner particles 1 were dried using a drying apparatus illustrated in FIG. 1 under the following conditions to obtain toner particles 1.

Gas flow speed A of gas supplied from the first blowing port: 10.0 m/s

Gas flow speed B of gas supplied from the second blowing port: 30.0 m/s

Relational expression C/(C+D) of a gas flow rate C of gas supplied from the first blowing port and a gas flow rate D of gas supplied from the second blowing port: 0.50

Gas temperature: 70° C.

Number of the second blowing ports: three

The measurement result of the glass transition temperature of the obtained toner particles 1 is shown in Table 2, and the water content of the toner particles 1 is shown in Table 3.

After the drying step, drying efficiency was evaluated under the present conditions by the amount of obtained toner particles having the water content of less than 1.0%. The evaluation criteria of drying efficiency were as follows.

A: 70 kg/h or more of the toner particles were obtained
B: 60 kg/h or more and less than 70 kg/h of the toner particles were obtained
C: 50 kg/h or more and less than 60 kg/h of the toner particles were obtained
D: less than 50 kg/h of the toner particles were obtained

Furthermore, the drying apparatus was disassembled, and the state of fusions of the inside of the drying pipe was checked by endoscopy or visual observation. The evaluation criteria for fusions of the toner particles were as follows.

A: No adhesion.
B: Some adhesion, but can be easily removed.
C: Frequent adhesion, and fused objects with a thickness of 1 mm or more and less than 1 cm.

D: Accumulated adhesion and fused objects with a thickness of more than 1 cm.

The evaluation results are shown in Table 3.

### Examples 2 and 3

Toner particles 2 were obtained under the same conditions and by the same method as in Example 1, except that the gas flow speed A of the gas supplied from the first blowing port was set to 4.6 m/s in the drying step. In addition, toner particles 3 were obtained under the same conditions and by the same method as in Example 1 except that the gas flow speed A of the gas was set to 14.3 m/s.

The measurement results of the glass transition temperatures of the obtained toner particles 2 and the obtained toner particles 3 are shown in Table 2, and the water contents of the toner particles 2 and the toner particles 3 are shown in Table 3. Evaluation was carried out in the same manner as in Example 1, and is shown in Table 3.

### Examples 4 and 5

Toner particles 4 were obtained under the same conditions and by the same method as in Example 1, except that the gas flow speed B of the gas supplied from the second blowing port was set to 19.0 m/s in the drying step. In addition, toner particles 5 were obtained under the same conditions and by the same method as in Example 1 except that the gas flow speed B of the gas was set to 38.4 m/s.

The measurement results of the glass transition temperatures of the obtained toner particles 4 and the obtained toner particles 5 are shown in Table 2, and the water contents of the toner particles 4 and the toner particles 5 are shown in Table 3. Evaluation was carried out in the same manner as in Example 1, and is shown in Table 3.

### Examples 6 and 7

Toner particles 6 were obtained under the same conditions and by the same method as in Example 1, except that the relational expression C/(C+D) of the gas flow rate C of the gas supplied from the first blowing port and the gas flow rate D of the gas supplied from the second blowing port was set to 0.20 in the drying step. In addition, toner particles 7 were obtained under the same conditions and by the same method as in Example 1 except that the relational expression C/(C+D) was set to 0.60.

The measurement results of the glass transition temperatures of the obtained toner particles 6 and the obtained toner particles 7 are shown in Table 2, and the water contents of the toner particles 6 and the toner particles 7 are shown in Table 3. Evaluation was carried out in the same manner as in Example 1, and is shown in Table 3.

### Examples 8 and 9

Toner particles 8 were obtained under the same conditions and by the same method as in Example 1, except that the temperature of the gas supplied from the first blowing port and the temperature of the gas supplied from the second blowing port were both set to 60° C. in the drying step. In addition, toner particles 9 were obtained under the same conditions and by the same method as in Example 1 except that the temperature of the gas supplied from the first blowing port and the temperature of the gas supplied from the second blowing port were both set to 80° C.

The measurement results of the glass transition temperatures of the obtained toner particles 8 and the obtained toner particles 9 are shown in Table 2, and the water contents of the toner particles 8 and the toner particles 9 are shown in Table 3. Evaluation was carried out in the same manner as in Example 1, and is shown in Table 3.

### Examples 10 and 11

Toner particles 10 were obtained under the same conditions and by the same method as in Example 1, except that the wet toner particles 2 instead of the wet toner particles 1 were dried in the drying step. In addition, toner particles 11 were obtained under the same conditions and by the same method as in Example 1 except that the wet toner particles 3 instead of the wet toner particles 1 were dried.

The measurement results of the glass transition temperatures of the obtained toner particles 10 and the obtained toner particles 11 are shown in Table 2, and the water contents of the toner particles 10 and the toner particles 11 are shown in Table 3. Evaluation was carried out in the same manner as in Example 1, and is shown in Table 3.

### Examples 12 and 13

Toner particles 12 were obtained under the same conditions and by the same method as in Example 1, except that the number of the second blowing ports was two in the drying step. In addition, toner particles 13 were obtained under the same conditions and by the same method as in Example 1 except that the number of the second blowing ports was one.

The measurement results of the glass transition temperatures of the obtained toner particles 12 and the obtained toner particles 13 are shown in Table 2, and the water contents of the toner particles 12 and the toner particles 13 are shown in Table 3. Evaluation was carried out in the same manner as in Example 1, and is shown in Table 3.

### Example 14

Toner particles 14 were obtained under the same conditions and by the same method as in Example 1, except that the relational expression C/(C+D) of the gas flow rate C of the gas supplied from the first blowing port and the gas flow rate D of the gas supplied from the second blowing port was set to 0.40 in the drying step.

The measurement result of the glass transition temperature of the obtained toner particles 14 is shown in Table 2, and the water content of the toner particles 14 is shown in Table 3. Evaluation was carried out in the same manner as in Example 1, and is shown in Table 3.

### Example 15

Toner particles 15 were obtained under the same conditions and by the same method as in Example 1, except that the drying apparatus illustrated in FIG. 2 instead of the drying apparatus illustrated in FIG. 1 was used in the drying step.

The measurement result of the glass transition temperature of the obtained toner particles 15 is shown in Table 2, and the water content of the toner particles 15 is shown in Table 3. Evaluation was carried out in the same manner as in Example 1, and is shown in Table 3.

### Comparative Example 1

The wet toner particles were dried under the same conditions and by the same method as in Example 1, except that the gas flow speed A of the gas supplied from the first blowing port was set to 4.2 m/s in the drying step. As a result, the wet toner particles flowed back to the first blowing port, and the toner particles could not be obtained.

### Comparative Example 2

Toner particles 16 were obtained under the same conditions and by the same method as in Example 1, except that the gas flow speed A of the gas supplied from the first blowing port was set to 14.6 m/s in the drying step. The measurement result of the glass transition temperature of the obtained toner particles 16 is shown in Table 2, and the water content of the toner particles 16 is shown in Table 3. Evaluation was carried out in the same manner as in Example 1, and is shown in Table 3.

### Comparative Examples 3 and 4

Toner particles 17 were obtained under the same conditions and by the same method as in Example 1, except that the gas flow speed B of the gas supplied from the second blowing port was set to 18.9 m/s in the drying step. In addition, toner particles 18 were obtained under the same conditions and by the same method as in Example 1, except that the gas flow speed B of the gas supplied from the second blowing port was set to 38.6 m/s.

The measurement results of the glass transition temperatures of the obtained toner particles 17 and the obtained toner particles 18 are shown in Table 2, and the water contents of the toner particles 17 and the toner particles 18 are shown in Table 3. Evaluation was carried out in the same manner as in Example 1, and is shown in Table 3.

### Comparative Examples 5 to 7

Toner particles 19 were obtained under the same conditions and by the same method as in Example 1, except that the relational expression C/(C+D) of the gas flow rate C of the gas supplied from the first blowing port and the gas flow rate D of the gas supplied from the second blowing port was set to 0.00 in the drying step. In addition, toner particles 20 were obtained under the same conditions and by the same method as in Example 1, except that the relational expression C/(C+D) was set to 0.18. Further, toner particles 21 were obtained under the same conditions and by the same method as in Example 1, except that the relational expression C/(C+D) was set to 0.61.

The measurement results of the glass transition temperatures of the obtained toner particles 19 to 21 are shown in Table 2, and the water contents of the toner particles 19 to 21 are shown in Table 3. Evaluation was carried out in the same manner as in Example 1, and is shown in Table 3.

### Comparative Examples 8 and 9

Toner particles 22 were obtained under the same conditions and by the same method as in Example 1, except that the temperature of the gas supplied from the first blowing port and the temperature of the gas supplied from the second blowing port were both set to 59° C. in the drying step. In addition, toner particles 23 were obtained under the same conditions and by the same method as in Example 1 except that the temperature of the gas supplied from the first blowing port and the temperature of the gas supplied from the second blowing port were both set to 81° C.

The measurement results of the glass transition temperatures of the obtained toner particles 22 and the obtained toner particles 23 are shown in Table 2, and the water contents of the toner particles 22 and the toner particles 23 are shown in Table 3. Evaluation was carried out in the same manner as in Example 1, and is shown in Table 3.

### Comparative Example 10

Toner particles 24 were obtained under the same conditions and by the same method as in Example 1, except that the temperature of the gas supplied from the first blowing port and the temperature of the gas supplied from the second blowing port were both set to 81° C. and the amount of the supplied wet toner particles was set to 80 kg/h in the drying step.

The measurement result of the glass transition temperature of the obtained toner particles 24 is shown in Table 2, and the water content of the toner particles 24 is shown in Table 3. Evaluation was carried out in the same manner as in Example 1, and is shown in Table 3.

TABLE 2

| | | | | Gas flow speed | | | | | | | |
|---|---|---|---|---|---|---|---|---|---|---|---|
| | | | | Gas | Gas | | | | | | |
| | | | | supplied | supplied | Gas | | Number | Glass | | |
| | | | | from the | from the | flow | | of | transition | | |
| | | Wet | | first | second | rate | Tem- | the | temperture | | |
| | | toner | Toner | blowing | blowing | ratio | perture | second | of toner | Dry | Configuration |
| | | par- | par- | port | port | C/ | of gas | blowing | particles | efficiency | of used |
| | | ticles | ticles | A (m/s) | B (m/s) | (C + D) | (° C.) | ports | (° C.) | (kg/h) | apparatus |
| Exam- | 1 | 1 | 1 | 10.0 | 30.0 | 0.50 | 70 | 3 | 55 | 72 | FIG. 1 |
| ple | 2 | 1 | 2 | 4.6 | 30.0 | 0.50 | 70 | 3 | 55 | 56 | FIG. 1 |
| No. | 3 | 1 | 3 | 14.3 | 30.0 | 0.50 | 70 | 3 | 55 | 73 | FIG. 1 |
| | 4 | 1 | 4 | 10.0 | 19.0 | 0.50 | 70 | 3 | 55 | 54 | FIG. 1 |
| | 5 | 1 | 5 | 10.0 | 38.4 | 0.50 | 70 | 3 | 55 | 74 | FIG. 1 |
| | 6 | 1 | 6 | 10.0 | 30.0 | 0.20 | 70 | 3 | 55 | 75 | FIG. 1 |
| | 7 | 1 | 7 | 10.0 | 30.0 | 0.60 | 70 | 3 | 55 | 63 | FIG. 1 |
| | 8 | 1 | 8 | 10.0 | 30.0 | 0.50 | 60 | 3 | 55 | 58 | FIG. 1 |
| | 9 | 1 | 9 | 10.0 | 30.0 | 0.50 | 80 | 3 | 55 | 74 | FIG. 1 |
| | 10 | 2 | 10 | 10.0 | 30.0 | 0.50 | 70 | 3 | 40 | 72 | FIG. 1 |
| | 11 | 3 | 11 | 10.0 | 30.0 | 0.50 | 70 | 3 | 38 | 72 | FIG. 1 |
| | 12 | 1 | 12 | 10.0 | 30.0 | 0.50 | 70 | 2 | 55 | 63 | FIG. 1 |
| | 13 | 1 | 13 | 10.0 | 30.0 | 0.50 | 70 | 1 | 55 | 55 | FIG. 1 |
| | 14 | 1 | 14 | 10.0 | 30.0 | 0.40 | 70 | 3 | 55 | 73 | FIG. 1 |
| | 15 | 1 | 15 | 10.0 | 30.0 | 0.50 | 70 | 2 | 55 | 63 | FIG. 2 |
| Com- | 1 | 1 | — | 4.2 | 30.0 | 0.50 | 70 | 3 | — | — | FIG. 1 |
| parative | 2 | 1 | 16 | 14.6 | 30.0 | 0.50 | 70 | 3 | 55 | 73 | FIG. 1 |
| Exam- | 3 | 1 | 17 | 10.0 | 18.9 | 0.50 | 70 | 3 | 55 | 47 | FIG. 1 |
| ple | 4 | 1 | 18 | 10.0 | 38.6 | 0.50 | 70 | 3 | 55 | 74 | FIG. 1 |
| No. | 5 | 1 | 19 | 10.0 | 30.0 | 0.00 | 70 | 3 | 55 | 75 | FIG. 1 |
| | 6 | 1 | 20 | 10.0 | 30.0 | 0.18 | 70 | 3 | 55 | 75 | FIG. 1 |
| | 7 | 1 | 21 | 10.0 | 30.0 | 0.61 | 70 | 3 | 55 | 64 | FIG. 1 |
| | 8 | 1 | 22 | 10.0 | 30.0 | 0.50 | 59 | 3 | 55 | 49 | FIG. 1 |
| | 9 | 1 | 23 | 10.0 | 30.0 | 0.50 | 81 | 3 | 55 | 75 | FIG. 1 |
| | 10 | 1 | 24 | 10.0 | 30.0 | 0.50 | 81 | 3 | 55 | 80 | FIG. 1 |

TABLE 3

| | | | Evaluation of drying | | |
|---|---|---|---|---|---|
| | | | | Amount of | |
| | | Evaluation | Water | processing | |
| | | of fusion | content (%) | (kg/h) | Evaluation |
| Example | 1 | A | 0.6 | 72 | A |
| No. | 2 | A | 0.7 | 56 | C |
| | 3 | C | 0.6 | 73 | A |
| | 4 | A | 0.7 | 54 | C |
| | 5 | C | 0.5 | 74 | A |
| | 6 | C | 0.3 | 75 | A |
| | 7 | A | 0.9 | 63 | B |
| | 8 | A | 0.6 | 58 | C |
| | 9 | C | 0.6 | 74 | A |
| | 10 | B | 0.6 | 72 | A |
| | 11 | C | 0.6 | 72 | A |
| | 12 | B | 0.6 | 63 | B |
| | 13 | C | 0.6 | 55 | C |
| | 14 | B | 0.5 | 73 | A |
| | 15 | C | 0.6 | 63 | B |
| Comparative | 1 | — | — | — | D |
| Example | 2 | D | 0.6 | 73 | A |
| No. | 3 | A | 0.7 | 47 | D |
| | 4 | D | 0.5 | 74 | A |
| | 5 | D | 0.1 | 75 | A |
| | 6 | D | 0.3 | 75 | A |
| | 7 | A | 1.3 | 64 | D |
| | 8 | A | 0.6 | 49 | D |
| | 9 | D | 0.6 | 75 | A |
| | 10 | D | 0.5 | 80 | A |

According to the present disclosure, it is possible to provide a method for manufacturing toner particles which suppresses fusions caused by collisions of wet toner particles with the inside of the drying pipe while drying treatment efficiency of an object to be treated is not lowered.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-126530, filed Aug. 2, 2021, which is hereby incorporated by reference herein in its entirety.

What is claimed is:

1. A method of manufacturing toner particles, comprising:
a step of drying wet toner particles with a drying unit, the wet toner particles being obtained from an aqueous dispersion medium,
wherein the drying unit comprises a loop-type flash dryer in which the wet toner particles to be dried are supplied to a gas stream circulating in a loop-type drying pipe,
the loop-type flash dryer comprises:
(i) a loop-type drying pipe;
(ii) an inlet port for supplying wet toner particles to the loop-type drying pipe;
(iii) an outlet port for discharging dried toner particles from the loop-type drying pipe;
(iv) a first blowing port for blowing gas into the loop-type drying pipe; and
(v) a second blowing port for blowing gas into the loop-type drying pipe,
the first blowing port is positioned upstream of the second blowing port with respect to a conveying path of the wet toner particles,
when a gas flow speed of the gas supplied from the first blowing port is defined as A (m/s);
a gas flow speed of the gas supplied from the second blowing port is defined as B (m/s);
a gas flow rate of the gas supplied from the first blowing port is defined as C (m³/s); and
a gas flow rate of the gas supplied from the second blowing port is defined as D (m³/s),
the A, B, C and D satisfy the following formulae (1), (2) and (3):
4.5≤A≤14.5 (1);
19.0≤B≤38.5 (2); and
0.20≤C/(C+D)≤0.60 (3), and
a temperature of a gas stream supplied from the first blowing port and a temperature of a gas stream supplied from the second blowing port are both 60° C. to 80° C.

2. The method of manufacturing toner particles according to claim 1, wherein the C and D satisfy the following formula (3)′:
0.40≤C/(C+D)≤0.60 (3)′.

3. The method of manufacturing toner particles according to claim 1, wherein the loop-type flash dryer comprises a plurality of the second blowing ports.

4. The method of manufacturing toner particles according to claim 1, wherein the toner particles have a glass transition temperature (Tg) of 40° C. or more.
